(19) United States
(12) Patent Application Publication
(10) Pub. No.: US 2002/0174007 A1
(43) Pub. Date: Nov. 21, 2002

(54) System and method for controlling and monitoring the distribution and use of portable digital media

(76) Inventors: Arlen B. Braunstein, Point Roberts, WA (US); Gray R. Smith, Vancouver (CA)

Correspondence Address: THOMAS J. OPPOLD, LARKIN, HOFFMAN, DALY & LINDGREN, LTD., 1500 WELLS FARGO PLAZA, 79*00 XERXES AVENUE SOUTH, BLOOMINGTON, MN, 55431, US

(21) Appl. No.: 09/860,845

(22) Filed: May 18, 2001

(51) Int. Cl. G06F 17/60

(52) U.S. Cl. 705/10

(57) ABSTRACT

A system and method for controlling and monitoring the distribution and use of computer-readable portable digital media (PDM), such as CD business cards and the like, between a PDM provider, the PDM provider's customer, the customer's representatives and associates (if any), and third party PDM recipients through the use of a database interfacing with Internet accessible Web sites controlled by the PDM provider. The PDM includes customer information digitally encoded thereon and preferably includes an Internet Web site URL link for accessing an Internet Web site transition page which interfaces with the database to redirect the third party recipient viewer's Internet browser to designated Internet destination page.

### CROSS-REFERENCE TO RELATED APPLICATIONS

Not Applicable

### STATEMENT REGARDING FEDERALLY SPONSORED RESEARCH OR DEVELOPMENT

Not Applicable

### REFERENCE TO MICROFICHE APPENDIX

Not Applicable

### BACKGROUND OF THE INVENTION

1. Field of the Invention

The present invention relates generally to portable digital media such as CD and DVD business cards and the like, and more particularly to a system and method for controlling and monitoring the distribution and use of said portable digital media.

2. Background

Promotional compact discs (CDs) or digital video discs (DVDs), commonly referred to as “CD business cards” or “e-cards” are well known. Like traditional paper business cards, CD business cards are distributed by representatives of businesses and organizations to third parties as a marketing tool. However, unlike traditional business cards, which typically include only general business contact information printed on the card, CD business cards are essentially a portable “infomercial,” capable of providing the third party recipient viewers a brief multimedia presentation of the business's or organization's goods or services along with any promotional message the business or organization would like to convey to the third party recipient viewers.

While CD business cards serve their intended purpose, there is no system or method currently available which allows businesses to effectively track the number of cards distributed to each of its representatives, or the ability to allow the business representatives to track and log the use of the CD business cards by third party recipient viewers. Instead, currently available CD business cards are treated much like traditional business cards, which are simply handed out to third parties with no means of tracking who the cards are distributed to, or the usage pattern of the cards thereafter. Additionally, there is no system or method currently available which enables the individual representatives of a business or organization to personalize or individualize the CD business cards while at the same time ensuring the business or organization that the standard information encoded on the CD remains consistent and unmodified. Allowing representatives of a business or organization to personalize or individualize the information which can be viewed by third parties through an Internet Web site URL link at the conclusion of the presentation on the CD business card is particularly important and useful in businesses, organizations, and individuals engaged in such industries as automobile sales, real estate, cosmetic sales (such as Avon® and Mary Kay®), direct marketing organizations (such as Amway® and Shaklee®), in the franchising industry, or in any other industry which has independent dealers or distributors operating under an umbrella organization. For example, in the automobile sales industry, it would be extremely useful for individual dealerships of an automobile manufacture, such as General Motors® (GM), to be able to distribute the GM business card CDs containing GM's standard promotional presentation showing and describing various makes and models of GM automobiles, while at the same time allowing the individual GM dealerships to individualize the GM business card CDs in such a way that third party recipient viewers of the CD business cards are directed to the particular Internet Web site of the GM dealership that actually distributed the card to the third parties. Thus, by allowing each individual GM dealership to personalizing or individualizing the GM business card CD, third party recipients of the CD business cards are directed to each individual dealership's Internet Web site to learn more about the dealership's location, services, promotions, etc., yet the standard GM promotional presentation remains consistent for each of its dealerships.

Accordingly, based on the foregoing, it has been shown that there is a need in these industries, among others, for an improved system and method that enables these and other important features and uses of portable digital media.

### BRIEF SUMMARY OF THE INVENTION

The present invention is a system and method for controlling and monitoring the distribution and use of computer-readable portable digital media (PDM), such as CD business cards and the like, between a PDM provider, the PDM provider's customer, the customer's representatives and associates (if any), and third party PDM recipients through the use of a database interfacing with Internet accessible Web sites controlled by the PDM provider.

The invention comprises the operation of producing a predefined series of computer-readable PDMs in accordance with a customers specifications with each PDM having the customer's predefined information digitally encoded thereon, along with an Internet Web site transition page link. Each PDM further having a unique serial number visually displayed thereon. The system and method of the present invention further comprises the operation of providing a computer database for associating each unique serial number of the predefined series of PDMs with the particular customer for whom the PDMs were produced. The system and method also includes the operation of activating the PDMs. The operation of activating the PDMs is preferably accomplished by associating a predefined sub-series of the predefined series of PDMs with a particular representative of the customer. Associating a representative with each serial number is preferably accomplished by the representative remotely accessing an Internet Web site administration page that interfaces with the database. Thus, representatives of the customer can preferably activate each of the PDMs allocated to the representative by the customer by opening the Internet Web site administration page and entering the PDM serial numbers. Preferably the activation operation also enables the representative to designate an Internet Web site URL of the representative's choice to be associated with each PDM serial number. Alternatively the PDM's could be activated and associated in an administrative process by others in the customer's business or organization on behalf of the representative. Once the PDMs are activated they are ready for distribution to third parties by the representative. Additionally, the system and method of the present invention preferably enables the representative to allocate any of its activated cards to one or more associates by associating the associate with the serial number. This operation can be performed either during the activation operation or at a later time through the administration page.

Preferably the Internet Web site transition page link, when selected by third parties running the PDM on their remote computer systems, automatically opens an Internet Web site transition page, preferably at the conclusion of the viewing of the information encoded on the PDM. The Internet Web site transition page preferably requires the third party recipient to enter the PDM serial number visually displayed on the PDM. Once the PDM serial number is entered, the transition page interfaces with the database which then logs the third party recipient's use of the PDM. The database also preferably maps the entered serial number with the representative's designated Internet Web site URL to redirect the third party recipient's Internet browser to the representative's Web site destination page corresponding to the designated Internet Web site URL. Additionally, upon opening the Internet Web site transition page, or in any event, before redirecting the third party's Internet browser to the representative's destination page, the transition page preferably provides the third party recipient viewer the option and/or choice to register by entering certain identifying information into the transition page. This identifying information is also then preferably logged by the database so that the representative can view a record of the third party's identifying information along with the number of times the third party has accessed the representative's destination site. The system and method of the present invention also preferably enables the customer to reallocate the PDMs to a different representative and also to enables the representative to reallocate the PDMs to a different associate.

### BRIEF DESCRIPTION OF THE DRAWINGS

These and other attributes of the invention will become more clear upon a thorough study of the following detailed description of the invention, particularly when reviewed in conjunction with the following drawing figures, wherein:

FIG. 1 is a diagram representing the organizational structure of the system and method of the present invention;

FIG. 2 is a drawing figure of one embodiment of a PDM used in the present invention;

FIG. 3 is a drawing figure showing one example of a form for entering customer information into fields of the database;

FIG. 4 is a drawing figure showing one example of a form for one of the Internet Web site administration pages for adding representatives into the database;

FIG. 5 is a drawing figure showing one example of a form for one of the Internet Web site administration pages for activating the PDMs;

FIG. 6 is a drawing figure showing one example of a form for the Internet Web site transition page;

FIG. 7 is a drawing figure showing one example of a form for one of the Internet Web site administration pages for clearing previously activated PDM serial numbers so the serial numbers can be reallocated to a different representative;

FIG. 8 is a drawing figure showing one example of a form for one of the Internet Web site administration pages for clearing previously activated PDM serial numbers so the serial numbers can be reallocated to a different associate;

FIG. 9 is a drawing figure showing one example of a report of third party use of the PDMs; and

FIG. 10 is a drawing figure showing one example of a form used for subsequent PDM orders of an existing customer.

### DETAILED DESCRIPTION OF THE INVENTION

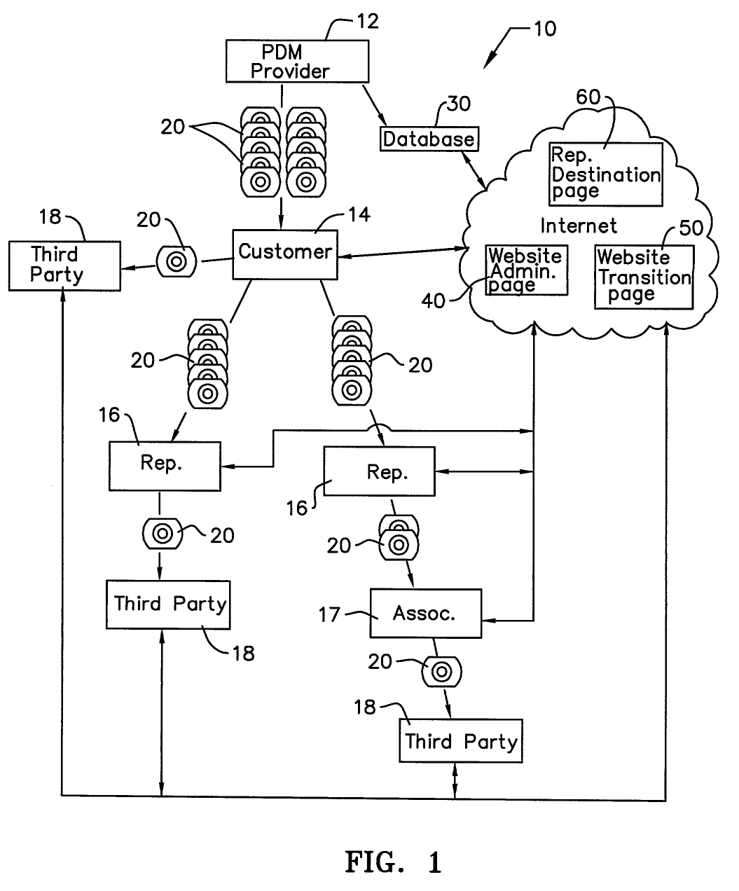

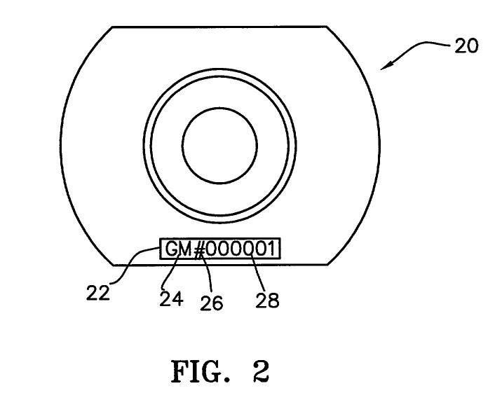

Referring to FIG. 1, the present invention (10) is a system and method for controlling and monitoring the distribution and use of computer-readable portable digital media (PDM) (20) (FIG. 2) between a PDM provider (12), the PDM provider's customers (14), the customer's representatives (16) and associates (17) (if any), and the third party PDM recipients (18) through the use of a database (30) interfacing with Internet accessible Web sites (40, 50) controlled by the PDM provider (12).

It should be understood that the term “PDM,” as used in this specification, is meant to include any type of computer-readable portable digital storage medium capable of being digitally encoded with data, including any type, size or capacity of disc, CD, DVD, optical disc or any other type of past, current, or after-developed digital data storage technology. It should also be understood that the term “customer” as used throughout this specification is meant to include individuals as well as any type of commercial or non-commercial businesses or organizations for whom the PDMs (20) are being produced. Additionally, the term “representative” as used in this specification is meant to refer to any distributors, members, independent contractors, agents, and/or individual employees of the customer (14). Similarly, the term “associates” is meant to refer to any distributors, members, independent contractors, agents, and/or individual employees of the representative (16). In the case of a customer (14) who is an individual, sole proprietorship, or small business, the customer (14), representative (16) and associate (17) may all be the same person.

Referring to FIG. 2, one embodiment of a typical PDM (20) is shown as a mini-CD. Each PDM (20) is digitally encoded with the information specified by the customer for whom the PDM is produced along with an Internet Web site universal resource locator (URL) for accessing an Internet Web site transition page (50) (FIG. 1) (discussed later). The type of information encoded on the PDM (20) may include information ranging from simple text to a full multimedia presentation of the customer's goods or services. The method of digitally encoding information on PDMs is well known to those skilled in the art and need not be described herein for understanding of the present invention. It should also be understood that the PDM provider (12) may or may not actually perform the process of encoding the specified customer information on the PDM (20). Instead, the encoding of the PDM, as well as the application of any logos, artwork or serial numbers (22) (discussed later) on the PDM (20) may be performed by others contracting with the PDM provider (12), such that the PDM provider (12) only accepts the customer orders for the PDMs (20) and administers and controls the database (30) and the Internet web pages (40, 50) that interface therewith.

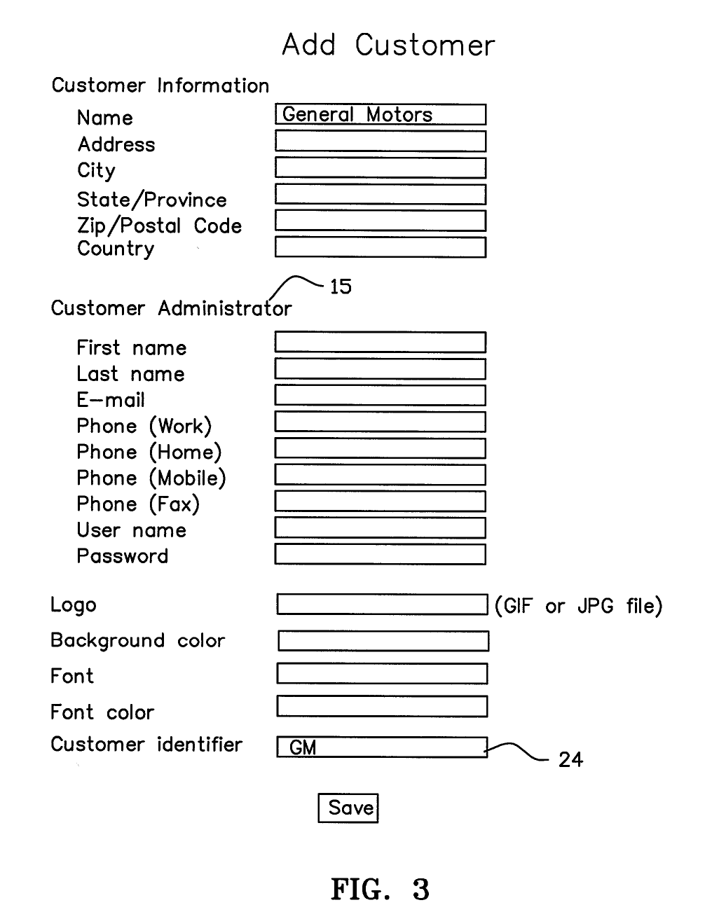

Referring now to FIG. 3 in combination with FIG. 1, when a new customer (14) places an order with the PDM provider (12) for a predetermined quantity of PDMs (20), relevant information about the customer (14) is entered by an employee of the PDM provider (12) into the database (30). Typically such relevant customer information includes the name, address and telephone number of the customer (14) and the identity of the designated customer administrator (18). Again, in the case of a customer (14) that is an individual, sole proprietorship, or small business, the customer (14), representative (16), associate (17), and customer administrator (15) may all be the same person. In addition to entering the relevant customer information into the database, the customer (14) is assigned a unique customer identifier (24) and a user name and password. Furthermore, the customer's company logo is preferably electronically stored as an image file in the database (30) along with the customer's preferences with respect to the background color, font and font color. When the customer (14), representatives (16) and/or associates (17) access the Internet Web site administration pages (40) (discussed later), the customer logo and customer preferences are preferably mapped to and displayed on the Internet Web site administration pages (40) accessed by the customer (14), representatives (16) and/or associates (17). Similarly, the customer logo and customer preferences are preferably mapped to and displayed on to the Internet Web site transition page (50) (also discussed later) accessed by the third party PDM recipients (18). It should be understood that the form shown in FIG. 3, with the various fields for entering the relevant customer information, is but one example of various database forms that could be used and therefore the present invention should not be considered as limited by the sample form shown.

Referring again to FIG. 2, visibly displayed on each PDM is a unique serial number (22). The unique serial number (22) may be printed, silk-screened, etched, etc., directly on the PDM (20) or it may be a label affixed to the PDM (20). In the preferred embodiment, the serial number (22) includes the customer identifier (24) followed by an unusual character (26) followed by the PDM number (28). The customer identifier (24) is preferably uniquely associated with the customer (14), for instance, as shown in FIGS. 2 and 3, the prefix “GM” may be used for General Motors. Immediately following the customer identifier (24) is an unusual character (26), for example a, “#”, “*”, “%”, “@”, “&” etc. The use of an unusual character (26) is preferred to visually separate the customer identifier (24) from the PDM number (28). The PDM number (28) is preferably a number corresponding to one of the number of PDMs the customer (14) has ordered. For example, as shown in FIGS. 2 and 3, if General Motors (GM) had placed an order for 10,000 PDMs (20), the serial numbers (22) visibly displayed on the PDMs (20) ordered by GM, would preferably start at “GM#000001” and continue sequentially through “XYZ#010000.” If GM ordered a second series of 10,000 PDMs at a later date, the serial numbers (22) visibly displayed on the second series of PDMs ordered, would preferably start with “GM#010001” and continue sequentially through “GM#020000.” In this way the PDM provider (12) will know immediately how many PDMs (20) each customer (14) has ordered. While the serial number system described above is the preferred method and format of assigning and displaying serial numbers (22) to a customer's PDMs (20), it should be understood that any numeric or alphanumeric numbering system may be used for the serial number (22), including any string of numbers, letters, symbols or characters, and therefore the present invention should not be considered limited to the preferred serial number format described herein. Furthermore, the serial numbers (22) could even be randomly generated and need not be sequentially numbered. All that is required is that each serial number (22) be unique.

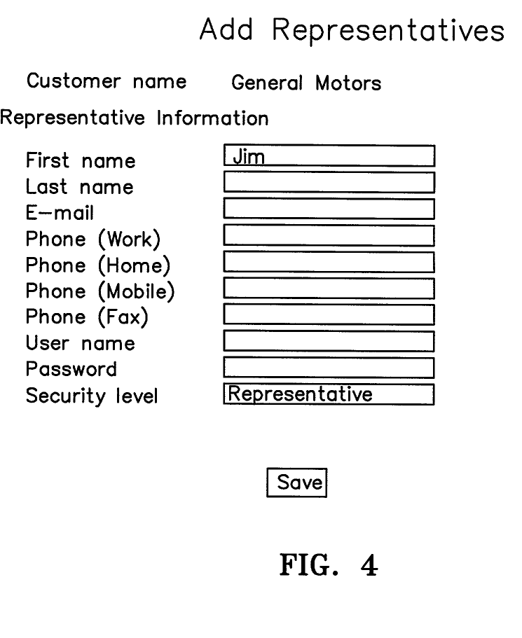

Referring again to FIG. 1, once each of the PDMs (20) have been encoded with the specified customer information and the URL link for the Internet Web site transition page (50), and a serial number (22) thereon, the finished PDMs (20) are then shipped to the customer (14). The customer (14), preferably through the customer administrator (15) may then distribute a series of PDMs (20) to each representative (16) (if any). Similarly, the representative (16) may then distribute the PDMs to the associates (17) (if any). However, preferably prior to any distribution to representatives (16) or associates (17), the customer administrator (15) preferably assigns a user name, password and security level designation to each representative (16) and associate (17) through an Internet Web site administration page (40), for example as shown in FIG. 4.

Once the representatives (16) and associates (17) have received their respective allotment of PDMs (20), the PDMs (20) are activated. Activating the PDMs is preferably performed by each representative (16) and/or associate (17) accessing an Internet Web site administration page (40), and entering the username and password previously assigned the representative (16) and/or associate (17) by the customer administrator (15). Because the representatives (16), associates (17) and customer administrator (15) each interface with the PDM provider's database (30) through an Internet Web site administration page (40), the security level designation associated with the representative's and/or associate's user names and passwords, preferably prevents the representatives (16) and/or associates (17) from viewing and changing any of the information entered by the customer administrator (15). It should be understood that any reference to an Internet Web site administration page (40) refers any one of a number of Internet webpages used to interface with the database (30) for entering and associating data therein.

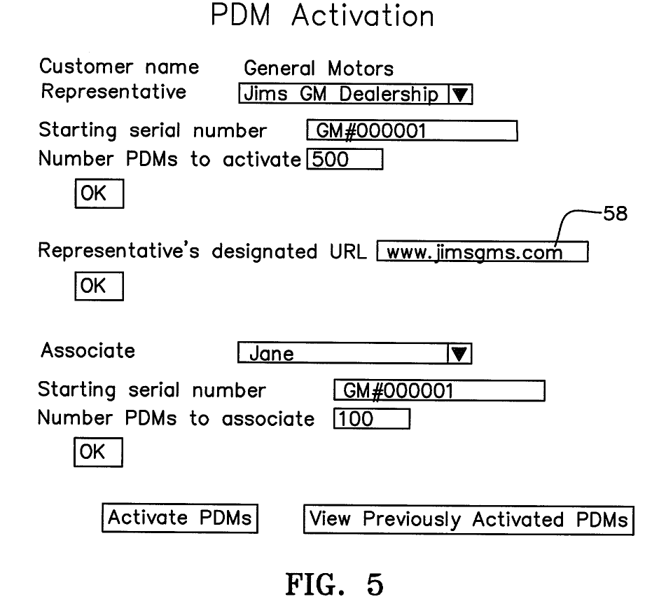

Once the representatives (16) interface with the database (30) through an Internet Web site administration page (40), the representatives (16) and/or associates activate their respective allotment of PDMs by entering the serial numbers (22) on the PDMs (20). For example, referring to FIG. 5, one such form for activating the PDMs (20) is shown. The representative (16) and/or associate (17) selects it's, or his or her name, preferably from a drop down list, previously entered by the customer administrator (15). The representative (16) and/or associate (17) may then associate it's, or his or her, name with a series of PDM serial numbers (22). Because the serial numbers (22) are preferably sequentially numbered, the database (30) preferably enables the representatives (16) and/or associates (17) to simply enter the starting serial number (22) and the total number of PDMs to activate. If the PDMs are not sequentially numbered, for example if the serial numbers (22) have been randomly generated, the representative (16) and/or associate (17) would have to enter the serial number (22) of each PDM to be activated. In order to exercise more control over the association of serial numbers with representatives (16) and/or associates (17) the customer administrator (15) may perform the activation task, or the representative (16) may perform the activation task for its or his or her associates (17).

An important, but optional, feature of the present invention (10) is the ability for each representative (16) to designate, at any time through an administration page (40), an Internet Web site URL (58) (FIG. 5) of the representative's choice, as the Internet Web site destination page (60) (FIG. 1) to which the third party PDM recipients (18) are intended to view (discussed later). The designated URL (58) is associated with each serial number activated by the representative (16) and/or associate (17).

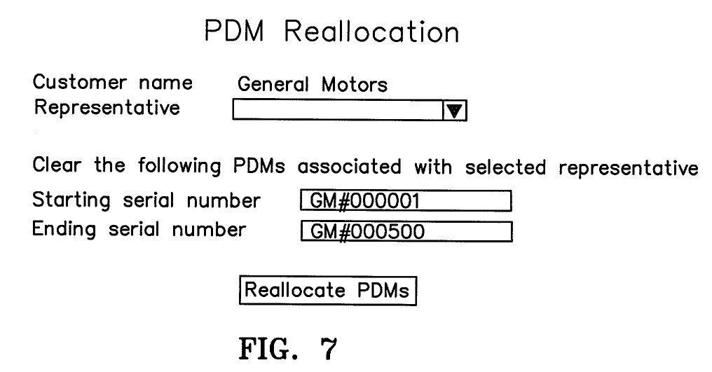

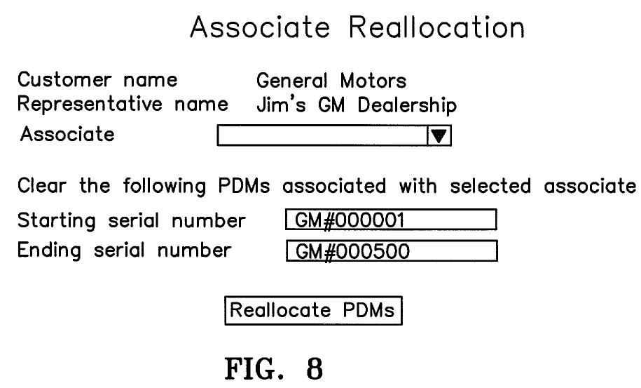

Referring to FIG. 7, another important but optional feature of the present invention (10) is the ability of the customer administrator (15) to reallocate previously activated PDMs (20) to different representatives (16) and/or associates (17). For example, if a first representative is terminated or wishes to return their allotted PDMs (20) to the customer (14), once the PDMs are returned to the customer (14) the PDMs alloted to the first representative can be reallocated to a second representative by simply clearing the name associated with the serial numbers (22). The customer administrator (15) and/or second representative (16) can then simply open an Internet Web site administration page (40) to reactivate the serial numbers (22) by associating the serial numbers (22) with the second representative. The second representative's designated URL (58) will then be associated with these reallocated serial numbers (22) as described above. Similarly, Referring to FIG. 8, the customer administrator (15) and/or representative (16) can reallocate the PDMs associated with a first associate (17) by clearing the first associate's name associated with the serial numbers (22) and replacing the first associate's name with a second associate's name.

Once a PDM (20) is activated by the customer (14), a representative (16), and/or an associate (17) it can be distributed to a third party (18) by any of these persons or entities as shown in FIG. 1. The third party recipient (18) can then view the customer's information encoded on the PDM (20) at his or her convenience by inserting the PDM (20) into any remote electronic computer system. It should be understood that electronic computer system refers to any device having a microprocessor, a video monitor or display screen, a PDM drive and a PDM drive controller (for example a floppy, CD, DVD or optical disc drive and controller) to control the communication of data between the PDM drive and the microprocessor for displaying the information encoded on the PDM on the video monitor or display screen. Additionally, the electronic computer system preferably includes a graphical user interface (GUI) and is preferably adapted to communicate data over the Internet. Examples of such computer systems include conventional desktop computers, laptop computers, and possibly, in the future, even wireless handheld communication devices, such as a wireless telephones, personal digital assistants (PDA), and the like, which have the ability to communicate data over the Internet via dial-up modems, digital subscriber lines (DSL), cable modems or wireless Internet connections, and have the ability to receive the PDM (20) and read and display the information encoded thereon on a display screen.

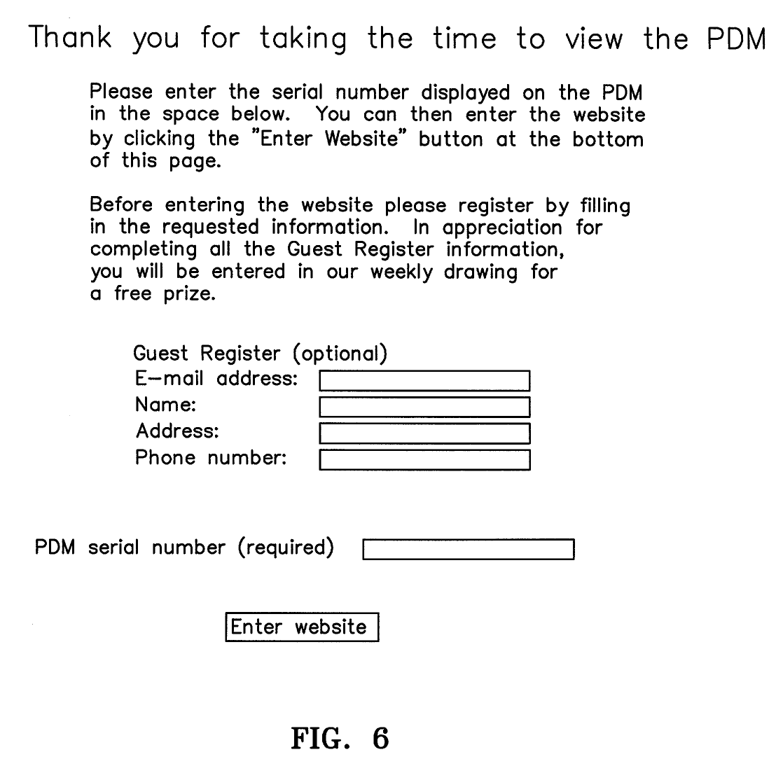

Preferably after viewing the information encoded on the PDM, at the end of the presentation, the third party PDM recipient (18) is prompted to “click” or select the Internet Web site link for accessing the transition page (50). The computer system then preferably automatically starts an Internet browser on the computer system and opens the Internet Web site transition page (50). As shown in FIG. 6, the Internet Web site transition page (50) preferably instructs the third party recipient viewer (18) to enter the serial number (22) visually displayed on the PDM (20). When the serial number (22) is entered into the appropriate field on the Internet Web site transition page (50), the transition page (50) interfaces with the database (30) which in turn maps the entered serial number (22) to the representative's designated Internet Web site URL previously associated therewith. Preferably, the third party recipient's Internet browser is then automatically redirected to the representative's Internet destination page (60) corresponding to the representative's designated Internet Web site URL (58), or, alternatively, the third party viewer (18) may be prompted to accept the link before opening the Internet destination page (60). Once the third party viewer (18) enters the representative's destination page (60) the third party viewer (18) is able to view the personalized or individualized information about the representative (16) as previously discussed.

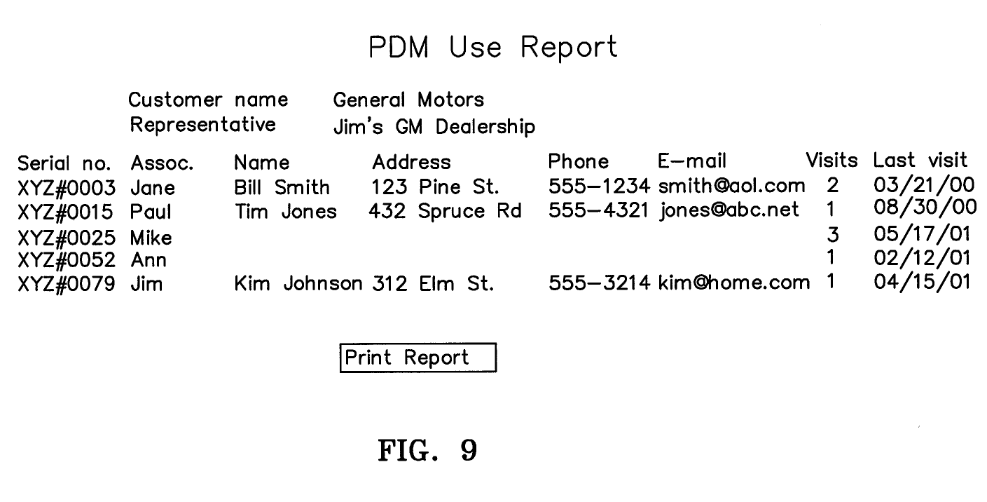

Preferably, prior to redirecting the third party viewer (18) to the Internet destination (60), the Internet Web site transition page (50) will also prompt or request the third party viewer (18) to register by entering identifying information such as the third party's name, address, telephone number and E-mail address. To facilitate registration, the third party viewer (18) may be notified that by completing the registration request, he or she would be entered into a drawing for a prize. If the third party viewer (18) enters the request information into the fields on the Internet Web site transition page (50), this information is logged into the database (30) along with the serial number (22) used to access the destination link (60). The third party viewer's registration information can then be viewed by the customer (14), representative (16) and/or associate (17) through an Internet Web site administration page (40), for example as shown in FIG. 9, by requesting a report of all serial numbers (22) associate with the representative (16) and/or associate (17) that have been entered by the third party recipients (18). The report may include such information as the serial number (22), the name, address, telephone number and E-mail of the third party viewer (18) and the third party viewer's last visit to the destination page (60). The third party viewer's registration information can then be used by the customer (14), representative (16) and/or associate (17) for ongoing marketing through, for example, an auto-respond E-mail campaign, as well as generating representative and customer reports on how many times each PDM serial number was used to access the destination page (60). If the third party viewer (18) does not register, the serial number (22) used to access the destination page (60) will still be logged by the database (30). Thus, regardless of whether the third party viewer (18) registers, the customer (14), representative (16) and/or associate (17) will know how many times the third party recipient (18) has used the PDM (20). It should be understood that if the third party recipient (18) passes the PDM (20) along to another person the database (30) will also log that other person's use of that PDM (20) as well, because the report is based on the third party entering the serial number (22) into the Internet Web site transition page (50). The representative (16), for example, will therefore know if the original third party recipient (18) passed the PDM (20) along to another person if different third party identifying information appears in the report under the same serial number (22). It should also be understood that if the third party recipient (18) is using a computer system that is not adapted to connect to the Internet, the third party can still view the customer's information encoded on the PDM (20), but the third party viewer (18) will not be able to access the Internet Web site transition page (50) in order to access the representative's destination link (60).

For ease of understanding of the organizational structure of the system and method of the present invention, by way of example, assume the customer (14) is an automobile manufacturer, such as General Motors (GM), and assume the representatives (16) are GM auto dealerships, and assume the associates (17) are individual sales personnel of the GM auto dealership representatives (16).

Using this example, assume that GM, the customer (14), places an order with a PDM provider (12) for 10,000 PDMs with a multimedia presentation of all the makes and models of GM's sport utility vehicles (SUVs). Upon placing the order, the PDM provider (12) enters GM's relevant customer information into the database (30) as shown in FIG. 3, for example. Additionally, GM is assigned a unique customer identifier (24) and a user name and password. Furthermore, GM's company logo is preferably electronically stored as an image file in the database (30) along with GM's preferences with respect to the background color, font and font color. As discussed above, GM's company logo and preferred background color, font and font color will then be displayed on the Internet Web site administration pages (40) accessed by its customer administrator (15), representatives (16) and/or associates (17), and on the Internet Website transition page (50) viewed by the third party PDM recipients (18).

The PDM provider (12) (or a subcontractor of the PDM provider as discussed above) then encodes each of the 10,000 PDMs in accordance with GM's specifications. In addition to digitally encoding each of the 10,000 PDMs (20) with GM's multimedia presentation of all its makes and models of SUVs, the PDM provider (12) digitally encodes an Internet Web site URL for accessing the Internet Web site transition page (50) onto the PDM (12), preferably at the end of the multimedia SUV presentation. Each of GM's PDMs (20) are also given a unique serial number (22), preferably sequentially numbered as described above from 1 to 10,000 preceded by GM's customer identifier (24) and a unique character (26). After the encoding and serial numbering is complete, the PDM provider (12) ships the 10,000 PDMs (20) to GM (14). GM then distributes the 10,000 PDMs (20), for example, in lots of 1000, to 10 dealership representatives (16). However, preferably before distributing the 1000 PDMs to each of its dealership representatives (16) GM's designated customer administrator (15) will have already accessed an Internet Web site administration page (40) (for example as shown in FIG. 4) using GM's designated username and password and entered each of the names of the 10 dealership representatives (16) into the database (30), along with a username, password, and security level designation. Upon receiving the 1000 PDMs from GM (14) each of the respective 10 dealership representatives (16) will enter an Internet Web site administration page (40) and select, preferably from a drop-down list, its respective name previously entered by the GM customer administrator (15). Upon entering the correct dealership representative's username and password, previously assigned by the customer administrator (15), the dealership representative (16) accesses the PDM activation page (for example as shown in FIG. 5) and enters the starting number of its allotment of PDMs (20) and the total number of PDMs received. For example, assuming the first representative (16) received the first 1000 PDMs beginning with the serial number GM#000001 and ending with GM#001000. The dealership representative (16) would enter GM#000001 as the start number and enter, for example 500 as the number of PDMs to activate. Thus, the PDMs having serial numbers GM#000001 through GM#000500 would be activated. In addition to entering the serial numbers (22) as just described, each dealership representative (16) can enter the URL address of for the dealership's Internet webpage as the designated URL address (58). As previously discussed, for each activated serial number (22), the database (30) will associate those activated serial numbers (22) for that dealership representative with that designated URL address (58). In addition to designating a URL address (58), the dealership representative (16) can also associate its sales personal associates (17) with a series of PDMs (20). For example, assume the dealership representative (16) has 5 salespersons. Each of these five salespersons can be designated as an associate (17) and each can be allocated 100 PDMs by entering the names of each of the five associates (17) to be associated with a series of 100 PDM serial numbers (22). After being allocated the activated PDMs, each salesperson associate (17) can begin distributing his or her PDMs (20) to third parties (18) by handing them out at the dealership to interested SUV purchasers. Alternatively, the salesperson associates (17) can mail them out to past SUV buyers that may be interested in purchasing a new GM SUV.

Upon receiving the PDM (20) a third party recipient (18) inserts the PDM into his or her computer system and views GM's multimedia presentation of its SUVs. After viewing the multimedia presentation, the third party recipient can click on the link for accessing the Internet Web site transition page (50). The Internet browser on the third party recipient's computer system is started and the Internet Web site transition page (50) is opened. The third party recipient (18) preferably registers by entering the requested information on the screen and then enters the serial number (22) visibly displayed on the PDM (20). Upon entering the serial number (22), the transition page (50) interfaces with the database (30) which maps the entered serial number (30) to the dealership representative's (16) designated Internet Web site URL (58). The third party recipient's Internet browser is then redirected to the dealership representative's Internet Web site destination page (60) corresponding to the designated URL (58). The third party recipient viewer (18) can then browse the representative's (16) Web site to find out what kind of deals the dealership is offering for the new GM SUVs.

When the third party recipient (18) enters the registration information and the serial number (22) into the Internet Web site transition page (50), the database (30) logs the entered information and serial number (22). The customer, GM, (14), the dealership representative (16) and/or the salesperson associate (17) can enter an Internet Web site administration page (40) and view the records, for example as shown in FIG. 9, of all the third party recipients (18) that have viewed the PDM and the destination page (60). The dealership representative (16) and/or the salesperson associate (17) can then follow-up with the prospective third party (18) buyer by sending letters, telephoning or E-mailing to sell a new GM SUV to the third party recipient (18).

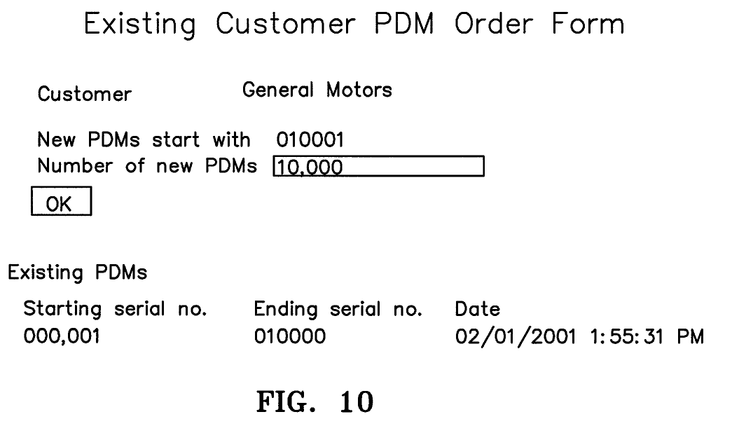

If GM places a second order for an additional 10,000 PDMs, for example, as shown in FIG. 10, the database preferably automatically identifies the starting number for the serial numbers (22) for the second order of PDMs (20) and displays any previous PDM orders. Although only an exemplary embodiment of the invention has been described in detail above, those skilled in the art will readily appreciate that many modifications are possible without materially departing from the novel teachings and advantages of this invention. Accordingly, all such modifications are intended to be included within the scope of this invention as defined in the following claims.

We claim:

1. A method of controlling and monitoring the distribution and use of computer-readable portable digital media (PDM), comprising the operations of:
a. producing a predefined series of computer-readable PDM for a customer, each PDM of said predefined series having a visible serial number thereon, and each said PDM of said predefined series further having customer information digitally encoded thereon;
b. providing a database for associating said customer with each said serial number;
c. distributing said predefined series of said PDM to said customer for subsequent distribution by said customer.

2. The method of claim 1 wherein said PDM further includes an Internet Web site transition page link digitally encoded thereon.

3. The method of claim 2 further comprising the step of said customer accessing an Internet Web site administration page which interfaces with said database and activating said PDM by entering said serial number into said Internet Web site administration page of each said PDM to be activated.

4. The method of claim 3 wherein said subsequent distribution step (c) of claim 1 includes distributing said activated PDM to third parties.

5. The method of claim 2 wherein said subsequent distribution step (c) of claim 1 includes distributing said PDM to at least one representative and further comprising the step of said representative accessing an Internet Web site administration page which interfaces with said database and activating said PDM by entering said serial number into said Internet Web site administration page of each said PDM to be activated.

6. The method of claim 5 wherein said activating step includes associating said at least one representative with said serial number of each said PDM to be activated.

7. The method of claim 6 further comprising the step of said at least one representative distributing said activated PDM to third parties.

8. The method of claim 6 wherein said activating step includes associating at least one associate with said serial number of each said PDM to be activated.

9. The method of claim 8 wherein said step of associating said at least one associate with said serial number of each said PDM to be activated is performed by said at least one associate.

10. The method of claim 8 further comprising the step of said at least one representative distributing said activated PDM to said at least one associate.

11. The method of claim 10 further comprising the step of said at least one associate distributing said activated PDM to third parties.

12. The method of claim 3 wherein said activating step includes associating said serial number with a designated Internet Web site URL selected by said customer for accessing an Internet Web site destination page.

13. The method of claim 12 wherein said Internet Web site transition page link encoded on said PDM enables a third party recipient of said PDM to enter said serial number in a field on said Internet Web site transition page whereupon said Internet Web site transition page interfaces with said database such that said third party recipient is linked to said Internet Web site destination page corresponding to said designated Internet Web site URL.

14. The method of claim 6 wherein said activating step includes associating said serial number with a designated Internet Web site URL selected by said at least one representative for accessing an Internet Web site destination page.

15. The method of claim 14 wherein said Internet Web site transition page link encoded on said PDM enables a third party recipient of said PDM to enter said serial number in a field on said Internet Web site transition page whereupon said Internet Web site transition page interfaces with said database such that said third party recipient is linked to said Internet Web site destination page corresponding to said designated Internet Web site URL.

16. The method of claim 9 wherein said activating step includes associating said serial number with a designated Internet Web site URL selected by said at least one associate for accessing an Internet Web site destination page.

17. The method of claim 16 wherein said Internet Web site transition page link encoded on said PDM enables a third party recipient of said PDM to enter said serial number in a field on said Internet Web site transition page whereupon said Internet Web site transition page interfaces with said database such that said third party recipient is linked to said Internet Web site destination page corresponding to said designated Internet Web site URL.

18. The method of claim 13 wherein said Internet Web site transition page logs said third party recipient's accessing of said Internet Web site destination page.

19. The method of claim 18 wherein said Internet Web site transition page enables said third party recipient to register by entering identifying information therein.

20. The method of claim 19 wherein said database logs any said third party recipient's identifying information entered into said Internet Website transition page.

21. The method of claim 20 wherein an Internet Web site administration page displays said third party recipient's accessing of said Internet Web site destination page and said any entered third party recipient identifying information.

22. The method of claim 15 wherein said Internet Web site transition page logs said third party recipient's accessing said Internet Web site destination page.

23. The method of claim 22 wherein said Internet Web site transition page enables said third party recipient to register by entering identifying information therein.

24. The method of claim 25 wherein said database logs any of said third party recipient's identifying information entered into said Internet Website transition page.

25. The method of claim 24 wherein an Internet Web site administration page displays said third party recipient's accessing of said Internet Web site destination page and said any entered third party recipient identifying information.

26. The method of claim 6 further comprising the step of reallocating each said activated PDM to a different representative.

27. The method of claim 8 further comprising the step of reallocating each said activated PDM to a different associate.
